(19) United States
(12) Patent Application Publication
(10) Pub. No.: US 2025/0284806 A1
(43) Pub. Date: Sep. 11, 2025

(54) ROBUST OUT-OF-DISTRIBUTION DETECTION SYSTEM AND METHOD

(71) Applicants: INVENTEC (PUDONG) TECHNOLOGY CORPORATION, Shanghai (CN); INVENTEC CORPORATION, Taipei City (TW)

(72) Inventors: Jeng-Lin LI, Taipei City (TW); Wei-Chao CHEN, Taipei City (TW); Ming-Ching CHANG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/665,267

(22) Filed: May 15, 2024

(30) Foreign Application Priority Data
Mar. 7, 2024 (CN) 202410263587.9

(51) Int. Cl. G06F 21/56

(52) U.S. Cl. CPC G06F 21/566; G06F 2221/034

(57) ABSTRACT

A robust out-of-distribution detection method includes a training phase and a testing phase. The training phase is configured to train a detection model according to in-distribution samples. The training phase includes a plurality of epochs, and one of the epochs includes: adding a perturbation to each in-distribution sample to generate an adversarial sample, inputting each adversarial sample into the detection model with branches, calculating a loss function of each branch to optimize the detection model. The testing phase includes: inputting the in-distribution samples into the detection model to generate in-distribution embeddings, inputting a test sample into the detection model to generate a test embedding, calculating a plurality of distances between the in-distribution embeddings and the test embedding, and selecting one of the distances as the out-of-distribution score for the test embedding. When the out-of-distribution score exceeds a threshold, the test sample is classified as out-of-distribution.

### CROSS-REFERENCE TO RELATED APPLICATIONS

This non-provisional application claims priority under 35 U.S.C. § 119(a) on Patent Application No(s). 202410263587.9 filed in China on Mar. 7, 2024, the entire contents of which are hereby incorporated by reference.

### BACKGROUND

### 1. Technical Field

The present disclosure relates to artificial intelligence and classification task, particularly to a system and method for out-of-distribution detection.

### 2. Related Art

Advancements in artificial intelligence (AI) go beyond mere model accuracy. One critical aspect is the AI model's capability to identify and reject unfamiliar samples, ensuring robust and reliable AI deployment. The technical field of detecting out-of-distribution (OOD) samples has raised substantial attention. The aim is to distinguish OOD samples that are disjoint from the in-distribution (ID) samples. For example, an image classifier should recognize unfamiliar input images outside its training classes to avoid generating unreliable predictions. This technology is essential for safe deployment in various applications, such as smart manufacturing, smart healthcare, and self-driving car.

Deep neural network is known to be vulnerable to adversarial attacks, which are intentionally manipulated perturbations in a subtle way that is malicious to mislead model predictions. A handful of adversarial defense studies are proposed to secure the model prediction against the attacks. These defense approaches can be organized into two categories: adversarial training and attack detection. Adversarial training, the predominant method, focuses on ensuring the model's proper functionality when facing attacks rather than merely detecting them. However, existing OOD detection studies have not yet explored how to distinguish adversarial ID from adversarial OOD samples. Thus, existing OOD detection solutions are still not resilient to attacks.

In addition, the task of differentiating OOD itself is hard due to the widespread types of input data that are new to the model. However, the possibility of suffering from adversarial attacks increases the complexity of OOD detection, as the loss landscape under optimization becomes highly sharp with adversarial samples.

### SUMMARY

In light of the above descriptions, the present disclosure aims to develop a robust OOD detection system and method that distinguish ID samples from OOD ones under adversarial conditions.

According to one or more embodiment of the present disclosure, an out-of-distribution detection method performed by a computing device includes a training phase and a testing phase. The training phase is configured to train a detection model according to a plurality of in-distribution samples. The training phase includes a plurality of epochs, and one of the plurality of epochs includes: adding a perturbation to each of the plurality of in-distribution samples to generate a plurality of adversarial samples; inputting each of the plurality of adversarial samples into the detection model, wherein the detection model includes a plurality of branches; and calculating a loss function of each of the plurality of branches to optimize the detection model. The testing phase includes: inputting the plurality of in-distribution samples into the detection model to generate a plurality of in-distribution embeddings; inputting a test sample into the detection model to generate a test embedding; calculating a plurality of distances between the plurality of in-distribution embeddings and the test embedding and selecting one of the plurality of distances as an out-of-distribution score of the test embedding; and when the out-of-distribution score exceeds a threshold, classifying the test sample as out-of-distribution.

According to one or more embodiment of the present disclosure, an out-of-distribution detection system includes a storage device, a computing device, and an output device. The storage device stores a plurality of instructions. The computing device electrically is connected to the storage device and is configured to perform a plurality of operations according to the plurality of instructions. The plurality of operations includes a training phase and a testing phase. The training phase is configured to train a detection model according to a plurality of in-distribution samples. The training phase includes a plurality of epochs, and one of the plurality of epochs includes: adding a perturbation to each of the plurality of in-distribution samples to generate a plurality of adversarial samples; inputting each of the plurality of adversarial samples into the detection model, wherein the detection model includes a plurality of branches; and calculating a loss function of each of the plurality of branches to optimize the detection model. The testing phase includes: inputting the plurality of in-distribution samples into the detection model to generate a plurality of in-distribution embeddings; inputting a test sample into the detection model to generate a test embedding; calculating a plurality of distances between the plurality of in-distribution embeddings and the test embedding and selecting one of the plurality of distances as an out-of-distribution score of the test embedding; and when the out-of-distribution score exceeds a threshold, classifying the test sample as out-of-distribution; and an output device electrically connected to the computing device and configured to display a classification result of the test sample.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flowchart of an OOD detection method according to an embodiment of the present disclosure;

FIG. 2 is a schematic diagram of an optimization of the detection model; and

FIG. 3 is a block diagram of an OOD detection system according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The present disclosure proposes an OOD detection method and system to tackle the sharp loss landscape issue inherently produced by the adversarial training process. The present disclosure targets the defense against challenging white-box attacks and seek effective perturbation strategies without relying on additional large outlier datasets.

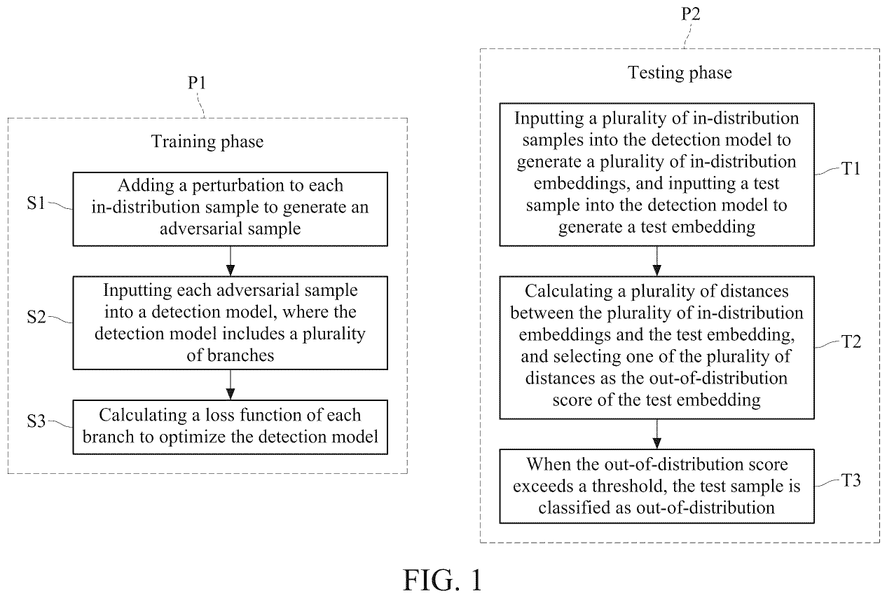

FIG. 1 is the flowchart of the OOD detection method according to an embodiment of the present disclosure. This method involves the execution of training and testing phases by a computing device. In an embodiment, the computing device may include, but is not limited to, one or more of the following examples: personal computers, network servers, central processing units (CPUs), graphics processing units (GPUs), microcontrollers (MCUs), application processors (APs), field programmable gate arrays (FPGAs), application-specific integrated circuits (ASICs), system-on-a-chip (SOC), deep learning accelerators, or any electronic devices with similar functionalities. The present disclosure does not limit the hardware type of the computing device.

The training phase P1 is configured to train a detection model f_{θ} according to a plurality of ID samples. In an embodiment, ID samples are, for example, CIFAR-10 or CIFAR-100, while any other dataset outside of these two datasets would be considered OOD. The training phase P1 includes a plurality of epochs, with each epoch comprising steps S1 to S3 as shown in FIG. 1

In step S1, the computing device adds a perturbation γ to each of the plurality of ID samples to generate a plurality of adversarial samples, i.e., employing adversarial training. In an embodiment, the computing device adjusts a magnitude of perturbation γ until the detection model f_{θ} misclassifies the adversarial samples.

To generate adversarial examples for robust ID training, in an embodiment, the computing device utilizes the Jitter adversarial attack to encourage diverse attack targets with a controlled perturbation bound. Each input sample x (ID sample) is perturbed by Jitter attack to simulate the attacked inputs during inference. Denote the perturbed samples as x_{γ}=x+γ, where ∥γ∥ₚ≤with an lₚ-norm bound. In an embodiment, the computing device selects p to be the infinite norm. The Jitter attack rescales the softmax function as:

$$\hat{h} = softmax ( α \cdot \frac{h}{{‖ h ‖}_{∞}} )$$

This is based on a finding that a small value range of output logits h can reduce the attack success rate. In an embodiment, α is chosen to be 10.

The optimization goal for the attacking model in adversarial training is to maximize the Euclidean distance L₂=∥ĥ−y∥₂ between the rescaled softmax output ĥ and the one-hot encoded ground truth vector y.

In an embodiment, the computing device further perturbs the target loss by adding a Gaussian noise [symbol] (0, σ) with magnitude σ. Such perturbed attack loss is then:

$${L}_{𝒩} = {‖ \hat{h} + 𝒩 ( 0 , σ ) - y ‖}_{2}$$

The attack needs to be constrained by a minimized perturbation norm which is optimized based on a search rule for smaller perturbations achieving the same success rate. Specifically, when the attack has successfully led to model misclassification, the computing device downscales the perturbation by a factor β. The Jitter loss is then:

$${L}_{Jitter} = \{ \begin{matrix}\frac{{‖ \hat{h} + 𝒩 ( 0 , σ ) - y ‖}_{2}}{β} & if {f}_{θ} ( {x}_{γ} ) = y \\ {‖ \hat{h} + 𝒩 ( 0 , σ ) - y ‖}_{2} & otherwise\end{matrix}$$

In step S2, the computing device inputs each of the plurality of adversarial samples into the detection model f_{θ}, where the detection model f_{θ} includes a plurality of branches. Specifically, the detection model f_{θ} proposed in the present disclosure is a Multi-Geometry Projection (MGP) network. In an embodiment, the detection model f_{θ} incorporates a dual-stream geometry projection to capture diverse latent structures in the data. Each geometry stream is defined by its specific loss function for joint optimization. In an embodiment, the plurality of branches includes a hypersphere manifold and a hyperbolic manifold, both Riemannian manifolds with positive and negative curvatures, respectively. The curvature serves as an indicator of deviation from the Euclidean space.

The parameter θ of the detection model f_{θ} resides on a Riemannian manifold [symbol] with the Riemannian metric tensor [symbol] . The metric tensor [symbol] : [symbol] × [symbol] consists of inner products in its tangent space [symbol] . A retraction map R_{θ} provides transformations from the Riemannian manifold [symbol] to the tangent space [symbol] . The tangent space [symbol] can be regarded as a measure of small deviation γ near the parameter θ, and the metric tensor [symbol] smoothly varies across a range of θ∈ [symbol] , resulting in the geodesic distance. The deviation γ on [symbol] is considered as the perturbation generated for adversarial training, which will be utilized in Riemannian manifold optimization.

The following explains Hypersphere Geometry and Hyperbolic Geometry separately.

The hypersphere geometry involves compactness and disparity loss functions to group data samples onto a hypersphere. These functions ensure that samples from different classes are kept at sufficient distances from each other. The hypersphere projection approach is based on the von Mises-Fisher (vMF) distribution assumption. It is calculated using a unit vector zₛ∈ [symbol] in class k and the class prototype μₖ as:

$${p}_{d} ( {z}_{s} ; {μ}_{k} ) = τ exp ( {μ}_{k {z}_{s}} / τ )$$

where τ is a temperature parameter.

The probability of the embedding zₛ assigned to class k is:

$$𝒫 ( y = k \vert {z}_{S} ; \{ {μ}_{k} , τ \} ) = \frac{exp ( {μ}_{{kz}_{s}} / τ )}{{\sum }_{j = 1}^{K} exp ( {μ}_{{jz}_{s}} / τ )}$$

In an embodiment, the computing device derives the compactness loss by taking negative log-likelihood, which compels the projected samples to stay near the class prototypes.

$${ℒ}_{com} = - \frac{1}{N} log \frac{exp ( {μ}_{{kz}_{s}} / τ )}{{\sum }_{j = 1}^{K} exp ( {μ}_{{jz}_{s}} / τ )} .$$

The disparity loss penalizes the class prototypes that are too close to each other:

$${ℒ}_{dis} = - \frac{1}{K} {\sum }_{i = 1}^{K} log \frac{1}{K - 1} {\sum }_{j = 1}^{K} {1}_{ji} exp ( {μ}_{i {μ}_{j}} / τ ) .$$

where 1ⱼᵢ is indication function,

$${1}_{ji} = \{ \begin{matrix}1 & if j \neq i \\ 0 & otherwise\end{matrix} .$$

The hypersphere loss function is [symbol] = [symbol] + [symbol] , which imposes constraints on intra-class compactness and inter-class disparity for ID clusters on the hypersphere. Meanwhile, OOD data are more likely to be separated farther from ID prototypes.

Hyperbolic Geometry: A hyperbolic space H^{d} consists of d-dimensional Riemannian manifolds with constant negative curvature. One of the isomorphic hyperbolic transformations, the Poincaré Ball D_{c}^{d}, g^{D}, defines a manifold D^{d}={u∈R^{d}:c∥u∥<1} equipped with the Riemannian metric

$${g}^{D} ( u ) = {( {λ}_{u}^{c} )}^{2} {g}^{E} = {( \frac{2}{1 - c {‖ u ‖}^{2}} )}^{2} I , where λ = \frac{2}{1 - c {‖ u ‖}^{2}}$$

is a conformal factor with curvature c, and g^{E}=I is an Euclidean metric tensor. The manifold operations involve Mobius gyrovector space, including Mobius addition ⊕_{c} and scalar multiplication ⊗_{c}, where u and v are vectors, and w is a scalar.

$$u {⊕}_{c} v = \frac{( 1 + 2 c < u , v > + c {‖ v ‖}^{2} ) u + ( 1 - c {‖ u ‖}^{2} ) v}{1 + 2 c < u , v > + {c}^{2} {‖ u ‖}^{2} {‖ v ‖}^{2}} ,$$

$$w {⊕}_{c} u = \frac{1}{\sqrt{c}} tan h ( w \cdot arctan h ( \sqrt{c} ‖ u ‖ ) )$$

The pairwise geodesic distance is in the following form for two points u and v:

$$D ( u , v ) = \frac{2}{\sqrt{c}} arc tan h ( \sqrt{c} ‖ - u {⊕}_{c} v ‖ )$$

Utilizing the operations of the hyperbolic space, the computing device projects the latent embedding with a hyperbolic head to derive the embedding u on the Poincaré ball. Considering an augmented set [symbol] from χ to form a full set [symbol] = [symbol] ∪χ, the supervised contrastive loss is calculated on the positive sample p(i) of the i∈ [symbol] in contrast to other augmented samples a∈ [symbol] . The supervised hyperbolic contrastive loss can thus be formulated as:

$${ℒ}_{hypb} = - {\sum }_{i ∈ 𝒥} \frac{1}{\vert P ( i ) \vert} {\sum }_{p ∈ P ( i )} log \frac{exp ( - D ( {z}_{i} , {z}_{{h}_{p}} ) / τ )}{{\sum }_{a ∈ 𝒜} exp ( - D ( {z}_{{h}_{i}} , {z}_{{h}_{a}} ) / τ )}$$

In step S3, the computing device calculates a loss function of each of the plurality of branches to optimize the detection model f_{θ}. In an embodiment, the overall loss function [symbol] + [symbol] + [symbol] is the combination of the hypersphere loss function and the hyperbolic loss functions, along with a cross-entropy loss [symbol] to optimize ID classification accuracy.

The multi-geometry projection of the latent layer may introduce undesirable peaks in the loss minimization process. Based on Sharpness-Aware Minimization (SAM), an embodiment of the present disclosure employs an improved approach for Riemannian manifolds, namely Riemannian Sharpness-Aware Minimization (RSAM), to accommodate the characteristics of the MGP network proposed in the present disclosure.

The consideration of multiple geometries in the network represents various manifolds that might not consistently converge in the same gradient direction. The recent work relying on a single hypersphere only accounts for a single underlying manifold, which limits the ability to represent the OOD space. In the scenario of the present disclosure, the target is to utilize the Riemannian manifold optimization strategy in the context of multiple geometries.

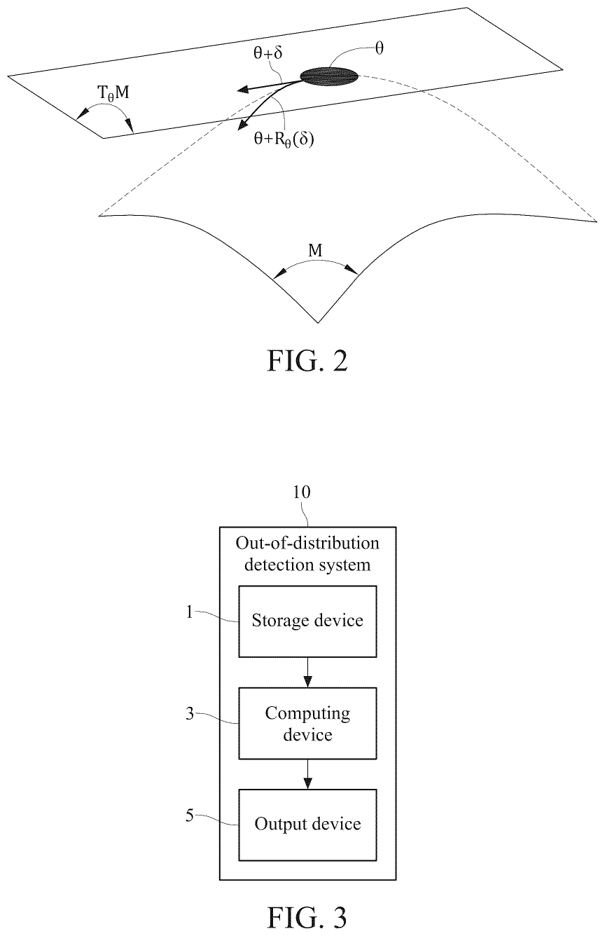

FIG. 2 is the schematic diagram of the optimization of the detection model. Given a loss function [symbol] (θ) with model parameter θ∈ [symbol] and retraction map R_{θ}, the manifold sharpness is defined as:

$${ℒ}_{S} = {max}_{{‖ δ ‖}_{θ}^{2} \leq ρ} ℒ ( {R}_{θ} ( δ ) ) - ℒ ( θ )$$

where δ is a projected perturbation in the tangent space [symbol] of the manifold [symbol] . The goal of minimization to eliminate the sharpness is expressed as

$${min}_{θ ∈ ℳ} {ℒ}_{S} .$$

In an embodiment, the computing device simplifies the first term in [symbol] using Taylor expansion to approximate perturbed loss in the maximization process:

$$ℒ ( {R}_{θ} ( δ ) ) \approx ℒ ( θ ) + {〈 {∇}_{θ} ℒ ( θ ) , δ 〉}_{θ}$$

where ∇_{θ} denotes the Riemannian gradient. A closed-form solution for [symbol] is picking δ equal to the Riemannian gradient within the upper bound ρ.

$$δ *= ρ \frac{{∇}_{θ} ℒ ( θ )}{{‖ {∇}_{θ} ℒ ( θ ) ‖}_{θ}} .$$

In an embodiment, the computing device projects δ* onto the tangent space via R_{θ} and derives the optimal parameter θ*=R_{θ}(δ*). The network parameter in the next training iteration θ′ can be updated using Riemannian gradient descent as:

$${θ}^{′} = {R}_{θ} ( - η \cdot {∇}_{θ} ( ℒ ( {θ}^{*} ) ) )$$

where η is the learning rate. During the adversarial training, the sharpness [symbol] on the loss landscape would unexpectedly increase. The solution in the present disclosure is the introduction of RSAM, which can regularize the network to increase convergence quality to retain robustness of the detection model f_{θ}.

The standard steps to detect OOD are as follows: (1) Train the detection model f_{θ} with the ID samples and freeze the model parameters θ. (2) Input testing data to the frozen model f_{θ}. (3) Calculate OOD score and differentiate OOD samples with a threshold.

The testing phase P2 includes steps T1 to T3. Specifically, the test samples x∈χ are fed into the detection model f_{θ}: χ→ [symbol] to predict label y∈ [symbol] , where ID denotes in-distribution and [symbol] ={y₁, y₂, . . . , y_{K}} with K classes. The detection model f_{θ} is trained using ID samples x drawn from the marginal distribution P_{χ}^{ID} and yields the latent embedding z. The present disclosure aims to detect OOD samples from P_{χ}^{OOD} during inference, where the corresponding OOD label space is potentially out of the [symbol] range.

In step T1, the computing device inputs T ID samples into the detection model f_{θ} to generate T ID embeddings Z_{T} (where T is the number of samples), inputs a test sample x into the detection model f_{θ} to generate a test embedding zₓ. Specifically, the computing device utilizes the trained detection model f_{θ} and extracts the penultimate layer output as the test embedding zₓ of the test sample x

In step T2, the computing device calculates a plurality of distances between T ID embeddings and the test embedding zₓ and selects one of the plurality of distances as an OOD score of the test embedding zₓ. Specifically, to distinguish between ID and OOD samples, the computing device calculates the L2 distance between the test sample x and each ID sample: s(x)=∥zₓ−zₖ∥₂, and selects the k^{th} smallest value as the OOD score s(x) of the test embedding zₓ. In an embodiment, the value of k may be set to 300, but the present disclosure is not limited to this.

In step T3, when the OOD score s(x) exceeds a threshold λ, the test sample x is classified as OOD. Specifically, the estimator g performs OOD detection according to the OOD score s(x) and the threshold λ:

$${g}_{λ} ( x ) = \{ \begin{matrix}ID & if s ( x ) \leq λ \\ OOD & otherwise\end{matrix}$$

During the testing phase, the present disclosure extracts the test embedding zₓ for each test sample x and calculates the OOD score s(x) by distance measurement to the ID embeddings zₖ. Finally, the OOD detection is implemented by comparing the OOD score s(x) with a predefined threshold λ.

FIG. 3 is the block diagram of the OOD detection system according to an embodiment of the present disclosure. As shown in FIG. 3, the OOD detection system 10 includes a storage device 1, a computing device 3, and an output device 5. The storage device 1 is configured to store a plurality of instructions. In an embodiment, the storage device 1 may be implemented using at least one of the following examples: flash memory, hard disk drive (HDD), solid-state drive (SSD), dynamic random-access memory (DRAM), static random-access memory (SRAM), or other non-volatile memory. However, the present disclosure is not limited to the examples mentioned above.

The computing device 3 is electrically connected to the storage device 1. The computing device 3 is configured to perform the OOD detection method described in FIG. 1 according to the instructions stored in the storage device 1.

The output device 5 is electrically connected to the computing device 3 and is configured to display a classification result of the test sample. In an embodiment, the output device 5 may be a display or communication device.

In view of the above, the OOD detection method proposed in the present disclosure enables training and inference of OOD detection on hyperspheres and hyperbolic manifolds. The present disclosure adopts an MGP network backbone and RSAM optimization method. During the training phase, adversarial samples are generated using Jitter attacks, and then the MGP network is trained. The training process employs RSAM for optimization to mitigate sharp loss landscapes. The trained model uses ID training data to extract ID embeddings. These ID embeddings are retained for the calculation of OOD scores.

What is claimed is:

1. An out-of-distribution detection method performed by a computing device comprising:
a training phase configured to train a detection model according to a plurality of in-distribution samples, wherein the training phase comprises a plurality of epochs, and one of the plurality of epochs comprises:
adding a perturbation to each of the plurality of in-distribution samples to generate a plurality of adversarial samples;
inputting each of the plurality of adversarial samples into the detection model, wherein the detection model includes a plurality of branches; and
calculating a loss function of each of the plurality of branches to optimize the detection model; and
a testing phase comprising:
inputting the plurality of in-distribution samples into the detection model to generate a plurality of in-distribution embeddings;
inputting a test sample into the detection model to generate a test embedding;
calculating a plurality of distances between the plurality of in-distribution embeddings and the test embedding and selecting one of the plurality of distances as an out-of-distribution score of the test embedding; and
when the out-of-distribution score exceeds a threshold, classifying the test sample as out-of-distribution.

2. The out-of-distribution detection method of claim 1, wherein adding the perturbation to each of the plurality of in-distribution samples to generate the plurality of adversarial samples comprises:
adjusting a magnitude of the perturbation with jitter adversarial attack until the detection model misclassifies the adversarial samples.

3. The out-of-distribution detection method of claim 1, wherein calculating the loss function of each of the plurality of branches to optimize the detection model comprises:
reducing a sharpness of an overall loss function by Riemannian sharpness-aware minimization, wherein the overall loss function is a sum of the loss function of each of the plurality of branches and a cross-entropy loss.

4. The out-of-distribution detection method of claim 1, wherein the plurality of branches comprises a hypersphere manifold and a hyperbolic manifold.

5. An out-of-distribution detection system, comprising:
a storage device storing a plurality of instructions;
a computing device electrically connected to the storage device and configured to perform a plurality of operations according to the plurality of instructions, wherein the plurality of operations comprises:
a training phase configured to train a detection model according to a plurality of in-distribution samples, wherein the training phase comprises a plurality of epochs, and one of the plurality of epochs comprises:
adding a perturbation to each of the plurality of in-distribution samples to generate a plurality of adversarial samples;
inputting each of the plurality of adversarial samples into the detection model, wherein the detection model includes a plurality of branches; and
calculating a loss function of each of the plurality of branches to optimize the detection model; and
a testing phase comprising:
inputting the plurality of in-distribution samples into the detection model to generate a plurality of in-distribution embeddings;
inputting a test sample into the detection model to generate a test embedding;
calculating a plurality of distances between the plurality of in-distribution embeddings and the test embedding and selecting one of the plurality of distances as an out-of-distribution score of the test embedding; and
when the out-of-distribution score exceeds a threshold, classifying the test sample as out-of-distribution; and
an output device electrically connected to the computing device and configured to display a classification result of the test sample.

6. The out-of-distribution detection system of claim 5, wherein adding the perturbation to each of the plurality of in-distribution samples to generate the plurality of adversarial samples comprises:
adjusting a magnitude of the perturbation with jitter adversarial attack until the detection model misclassifies the adversarial samples.

7. The out-of-distribution detection system of claim 5, wherein calculating the loss function of each of the plurality of branches to optimize the detection model comprises:
reducing a sharpness of an overall loss function by Riemannian sharpness-aware minimization, wherein the overall loss function is a sum of the loss function of each of the plurality of branches and a cross-entropy loss.

8. The out-of-distribution detection system of claim 5, wherein the plurality of branches comprises a hypersphere manifold and a hyperbolic manifold.
